(19) United States
(12) Patent Application Publication
(10) Pub. No.: US 2009/0291290 A1
(43) Pub. Date: Nov. 26, 2009

(54) PACKAGING MATERIAL AND METHOD FOR MAKING THE SAME

(75) Inventors: SHAO-HUI ZHANG, Shenzhen City (CN); JIAN-BIN DENG, Shenzhen City (CN); YI ZHAO, Shenzhen City (CN); JIANG YU, Shenzhen City (CN); BO LIU, Shenzhen City (CN); QING-MING YUAN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/339,278

(22) Filed: Dec. 19, 2008

(30) Foreign Application Priority Data
May 20, 2008 (CN) 200810301677.3

(51) Int. Cl. B32B 5/14

(52) U.S. Cl. 428/308.4; 428/309.9

(57) ABSTRACT

A packaging material is provided which includes a substrate (11) and a cushioning layer (13) formed on one surface of the substrate. The substrate consists of polystyrene and additives. The cushioning layer is made of silica gel. The present packaging material has better shock absorption performance. A method for making such package material is provided.

### BACKGROUND

1. Field of the Invention

The invention relates to packaging materials, particularly to a packaging material for cushioning and a method for making the same.

2. Description of Related Art

Foam polystyrene material is widely used as a packaging material for packing electronic devices such as mobile telephones and electronic notebooks.

However, foam polystyrene material lacks cushioning ability, because its low surface cushioning coefficient usually results in surface abrasions to the packed electronic devices. Furthermore, the foam polystyrene material may create powder pollution that may damage the packed electronic devices.

Therefore, there is room for improvement within the art.

### BRIEF DESCRIPTION OF THE DRAWINGS

Many aspects of the exemplary packaging material and a method of making the packaging material can be better understood with reference to the following drawings. These drawings are not necessarily drawn to scale, the emphasis instead being placed upon clearly illustrating the principles of the exemplary material and method. Moreover, in the drawings like reference numerals designate corresponding parts throughout the several views. Wherever possible, the same reference numbers are used throughout the drawings to refer to the same or like elements of an embodiment.

FIG. 1 is an isometric and partial view of a packaging material in form of a packaging film in accordance with an exemplary embodiment.

FIG. 2 is a block diagram of a process for making the packaging material.

### DETAILED DESCRIPTION OF THE EXEMPLARY EMBODIMENTS

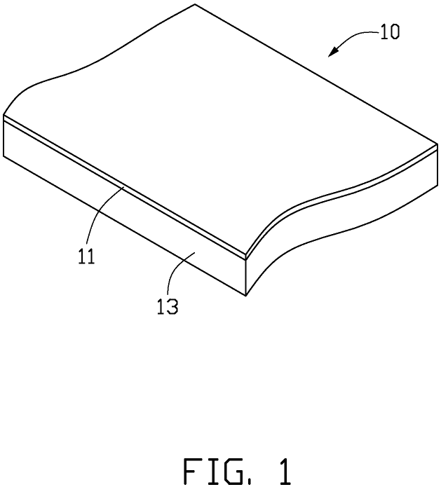

FIG. 1 shows a packaging material in form of a packaging film 10. The packing film 10 includes a substrate 11, and a cushioning layer 13 bonded to the substrate 11. The substrate 11 contains polystyrene and an additive. The additive is calcium carbonate. The weight ratio of the additive relative to the polystyrene is from about 1:12 to about 1:8. The ratio of this embodiment can be selected as about 1:10.

The cushioning layer 13 may be made of a silica gel material. The silica gel material may be aminopropylsilanized silica gel. Because the cushioning layer 13 may be thinner than the substrate 11, the weight ratio of the silica gel material to the polystyrene material may be from about 4□110 to about 6□90, and is selected as about 5:100 in this embodiment.

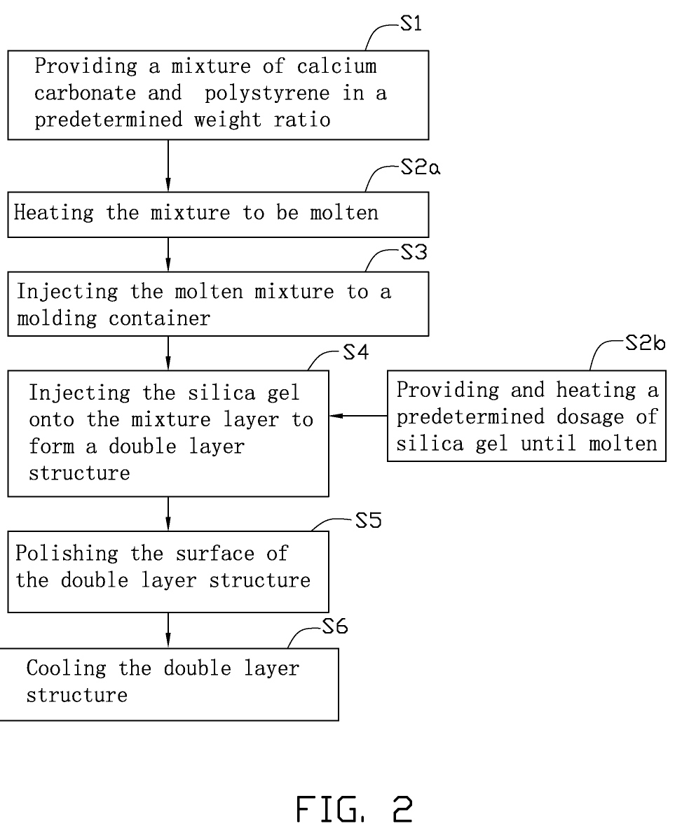

Referring to FIG. 2, the packaging material according to the present embodiment is prepared by a method comprising steps S1 to S6.

In step S1, a solid mixture of a calcium carbonate material and a polystyrene material (e.g. polystyrene grain material) is provided in a ratio of weight, from about 1:12 to about 1:8.

In step S2a, the solid mixture is melted and maintained at a temperature of about 195 to 205 degrees Centigrade.

In step S2b, a predetermined amount of the silica gel material (such as aminopropylsilanized silica gel grains) is provided. The silica gel material is melted and maintained at a temperature of about 195 to 205 degrees Centigrade.

In step S3, the melted mixture of the polystyrene material and the calcium carbonate material is injected into a molding container to form a melted mixture layer.

In step S4, the melted silica gel material is injected to the melted mixture layer in the molding container to integrally form a double layer structure. The melted mixture layer should maintain its melted state during injecting the silica gel material to achieve a good heat bonding effect between the silica gel material and the melted mixture layer.

In step S5, the double layer structure may be polished to achieve a smooth surface by pressing before the double layer structure completely cools down.

In step S6, the packaging film 10 is obtained by natural cooling of the polished double layer structure.

It is to be understood that using the packing film 10, many kinds of packing articles (e.g., package container, cushion, and transporting tray) can be obtained by thermoforming. In case of the packaging material being used to making transporting tray, the thickness of the cushioning layer of the transporting tray may be about 0.05 mm, and the substrate of the transporting tray may be about 1 mm.

Because the cushioning layer 13 of the silica gel material is provided with a large static friction coefficient (about 0.9) and the polystyrene substrate 11 is provided with a high strength and a good rigidity, the packaging film 10 has a good rigidity, a high strength and good cushion properties. Moreover, the packaging film 10 using the silica gel material as the cushioning layer does not create powder pollution that may damage the packed electronic device.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A packaging material, comprising:
a substrate made of polystyrene and an additive; and
a cushioning layer bonded to the substrate, the cushioning layer made of silica gel.

2. The packaging material as claimed in claim 1, wherein the additive is calcium carbonate.

3. The packaging material as claimed in claim 2, wherein the weight ratio of the calcium carbonate to the polystyrene is from about 1:12 to about 1:8.

4. The packaging material as claimed in claim 1, wherein the silica gel is aminopropylsilanized silica gel.

5. The packaging material as claimed in claim 1, wherein the thickness of the cushioning layer is less than that of the substrate.

6. A method of making a packaging material, comprising steps of:
providing a solid mixture of calcium carbonate and a polystyrene material in a predetermined weight ratio;
heating the mixture until molten and then maintaining the molten state;
providing and heating a predetermined amount of silica gel until molten and then maintaining the molten state;
injecting the molten mixture of polystyrene and calcium carbonate into a molding container;
injecting the molten silica gel onto the mixture layer in the molding container to integrally form a double layer structure; and
cooling the double layer structure.

7. The method of making a packaging material as claimed in claim 6, further comprising a step of pressing and polishing the surface of the double layer structure.

8. The method of making a packaging material as claimed in claim 6, wherein the weight ratio of the calcium carbonate to the polystyrene is from about 1:12 to about 1:8.

9. The method of making a packaging material as claimed in claim 6, wherein the silica gel is aminopropylsilanized silica gel.
